(19) United States
(12) Patent Application Publication
(10) Pub. No.: US 2025/0008416 A1
(43) Pub. Date: Jan. 2, 2025

(54) AUTOMATIC NEIGHBOR RELATIONS AUGMENTION IN A WIRELESS COMMUNICATIONS NETWORK

(71) Applicant: TELEFONAKTIEBOLAGET LM ERICSSON (PUBL), Stockholm (SE)

(72) Inventors: Eugene Gomes, Plano, TX (US); Xin Li, Plano, TX (US)

(21) Appl. No.: 18/583,309

(22) Filed: Feb. 21, 2024

Related U.S. Application Data
(60) Provisional application No. 63/486,120, filed on Feb. 21, 2023.

(51) Int. Cl. H04W 48/10

(52) U.S. Cl. CPC H04W 48/10

(57) ABSTRACT

According to an example embodiment, a network node for augmenting automatic neighbor relations in a wireless communication network carries out a method in which a list of neighbors of a cell in the wireless communication network and at least one performance characteristic associated with each of one or more of the neighbors are obtained. The network node determines a distance of each of the one or more neighbors from the cell and determines a distance threshold based on the at least one performance characteristic. The network node compares the distance of the one or more neighbors to the distance threshold, and, based on the distance threshold comparison, disables one or more neighbors in the list from operating as a neighbor for the cell.

### RELATED APPLICATIONS

This application claims the benefit of U.S. Provisional Application No. 63/486,120, filed Feb. 21, 2023, the disclosure of which is fully incorporated herein by reference.

### TECHNICAL FIELD

Embodiments described herein relate to methods and apparatuses for enabling self-organizing network (SON) operations in cellular telecommunications networks and, more particularly, augmentation of automatic neighbor relations (ANR) determinations in cellular telecommunications networks.

### BACKGROUND

ANR is a SON-based, 3GPP-defined feature used in a radio access network (RAN) to automatically define neighbor relations between radio cells in the RAN. For example, ANR automatically detects and adds missing neighbor relationships between radio cells. In the non-standalone NR networks, ANR also defines neighbors that could serve as anchors for the source NR cell. (For brevity, a neighbor relation or relationship may also be referred to herein as simply a neighbor because identifying a neighbor from the perspective of a particular cell is the same as identifying a neighbor relationship.)

There currently exist certain challenge(s) in relation to ANR. For instance, the addition of these neighbor relationships is based on user equipment (UE) based measurement reports and in some cases, neighbors are added by ANR which are very distant. These distant neighbor additions are caused by radio frequency propagation anomalies such as ducting, radio signal scatter, radio signal reflection etc. In many cases these neighbors remain relevant due to regular interaction with the source cell. However, these distant neighbors sometimes have very poor handover performance from and to the source cell. This poor performance directly translates to poor user perception of the network and can subsequently impact critical services offered by the network.

### SUMMARY

Certain aspects of the disclosure and their embodiments may provide solutions to these or other challenges. According to one embodiment, neighbors added by ANR are identified and disabled based on performance and distance. The solution does this for each source radio cell per neighbor band or frequency. It is also able to identify neighbors where distance is not the cause of poor performance. The solution evaluates neighbors that were previously disabled and can reenable those neighbors if certain criteria are met. For example, if a new neighbor is added that is more distant than a nearer disabled neighbor, the latter can be reenabled.

For each cell in the radio network, the solution can intelligently determine an optimal maximum distance beyond which the cell's neighbors will not perform well. The optimal distance threshold is determined individually per cell and per unique neighbor band or frequency relation level. The optimal distance threshold value is based on an assessment of one or more performance criteria derived from, e.g., network performance measurements, and a distance calculation, derived using various methods compared with successful handovers for all relevant neighbors. Once the optimal distance has been computed, the solution can proceed to automatically disable poorly performing neighbors that are located further than this optimal distance. The solution can also automatically track previously disabled neighbors and reenable these neighbors if a good newer performing more distant neighbor is detected.

Embodiments described herein are intended to complement ANR by detecting and intelligently disabling relations identified by ANR based on distance between the source cell and the neighbor cell. The embodiments are not limited to use with any specific communication technology or cell type.

Certain embodiments may provide one or more of the following technical advantage(s).
an optimal distance may be determined for every cell and each of its neighbor frequencies in the radio network,
an existing 3GPP SON ANR feature may be complemented and/or augmented,
comprehensive intelligence derived from network performance per cell and neighbor relation may be used to make neighbor decisions,
an optimal cellular network neighbor list may be managed by keeping only the best performing neighbors and disabling the poor performing ones,
a historical record of all previously disabled neighbors may be kept,
network changes may be detected automatically and previously disabled neighbors may be reenabled if a better more distant neighbor is detected,
anomalous neighbors per cell and/or neighboring frequency relation level may be determined,
may work with multiple technologies and/or cell types and may be independent of technology, e.g., may be implemented in any one of the following scenarios: LTE to LTE, LTE to NR, NR to LTE, NR to anchor.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a first flowchart depicting a method in accordance with an embodiment.

FIG. 2 is a second flowchart depicting a method in accordance with an embodiment.

FIG. 3 is a functional block diagram of a communication system in accordance with an embodiment.

FIG. 4 is a functional block diagram of a user equipment in accordance with an embodiment.

FIG. 5 is a functional block diagram of a network node in accordance with an embodiment.

FIG. 6 is a functional block diagram of a host in accordance with an embodiment.

FIG. 7 is a functional block diagram of a virtualization environment in accordance with an embodiment.

FIG. 8 is a functional block diagram of a communication system comprising a host, a network node, and a user equipment in accordance with an embodiment.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface may have suitable radio communications circuitry. Moreover, where appropriate the technology can additionally be considered to be embodied entirely within any form of computer-readable memory, such as (ROM, EEPROM, Flash memory, a memory disc, RAM etc.) solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Certain aspects of the present disclosure and their embodiments may provide solutions to these or other challenges.

Particular embodiments are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Some of the embodiments contemplated herein will now be described more fully with reference to the accompanying drawings. Embodiments are provided by way of example to convey the scope of the subject matter to those skilled in the art.

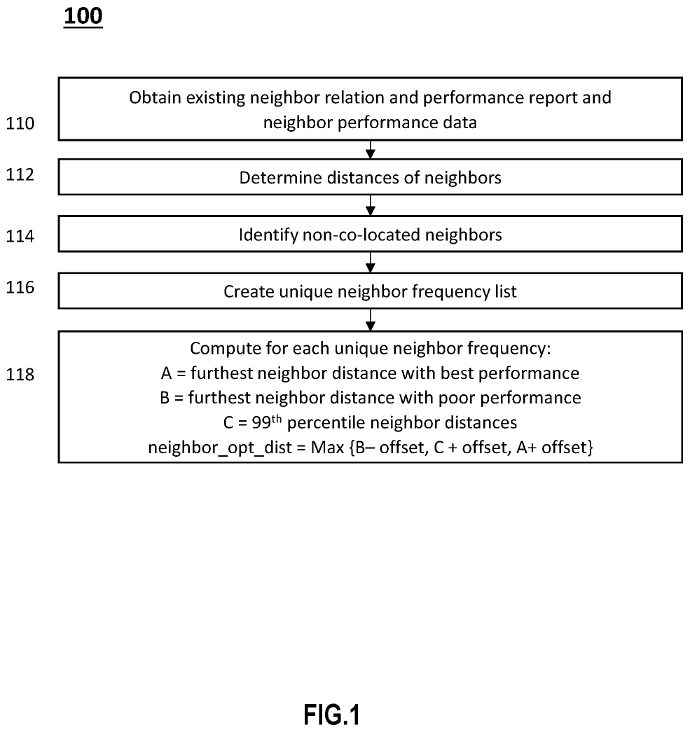

FIG. 1 is an example method 100 of computing an optimal distance threshold for a particular cell in a wireless communication network. The method 100 may be repeated for one or more neighbor cell frequencies operable with a cell to determine one or more optimal distance thresholds. Moreover, method 100 may be repeated over a longer repetition cycle (e.g., one day according to a non-real time rApp process in a scheduler) for one or more cells. In one embodiment the neighbor cell frequencies are target anchor cell frequencies in a 5G non-standalone network and the neighbor cells operate implement 4G/LTE communication protocols to communicate with wireless terminals whereas the cell for which an optimal distance threshold is being determined implements 5G/NR communication protocols to communicate with wireless terminals.

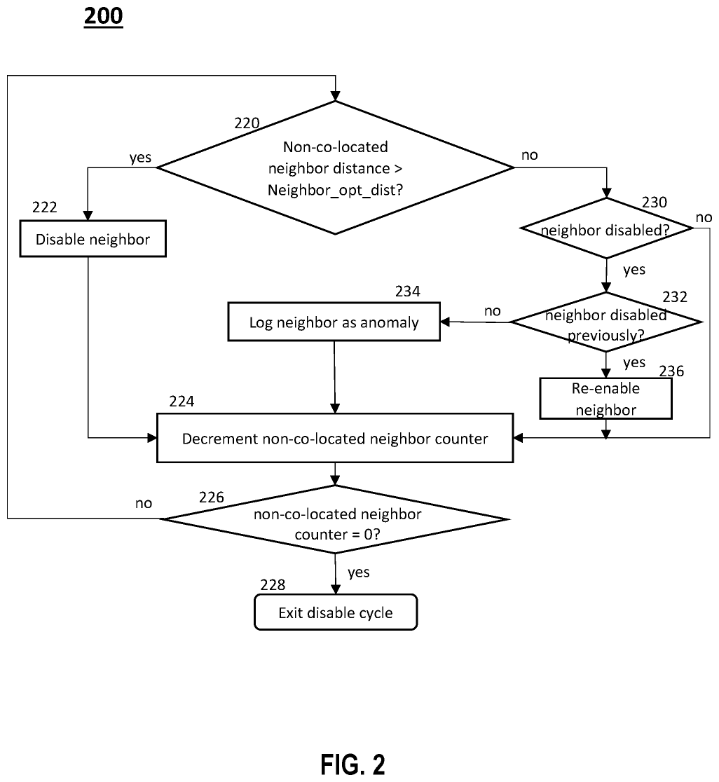

FIG. 2 is an example method 200 of using the computed optimal distance threshold to determine which neighbors identified for a cell exceed the optimal distance threshold and should therefore be disabled (i.e., not allowed to operate as a neighbor in the neighbor relations list for the cell). The distance of a neighbor from a cell may be determined using geographic coordinate information for a transmission point associated with the neighbor and geographic coordinate information for a transmission point associated with the cell. The method 200 may also include additional optional steps to determine if a disabled neighbor is to be re-enabled based on the optimal distance threshold or tracked as an anomaly when poor performance is not related to distance. The method 200 may be iterated for each of a plurality of neighbor cell frequencies and corresponding optimal distance thresholds. Moreover, method 200 may be repeated over a longer repetition cycle (e.g., one day) for one or more cells.

The method 100 includes a sequence of steps. In Step 110 a list of neighbors and neighbor performance data is obtained for the cell under evaluation. The list includes neighbors from an existing neighbor relation list and from a performance report. The existing neighbor list may correspond to a list of neighbors output by a known ANR procedure. The performance report may correspond to a list of neighbors that meet one or more performance criteria but that are not included in the existing neighbor relation list. The neighbor performance data may include performance characteristics associated with each neighbor, such as a number of successful handover operations the neighbor has performed with the cell under evaluation over a predetermined period of time and/or a rate or frequency of handover successes with the cell under evaluation over a predetermined period of time. The existing neighbor relation list, performance report, and neighbor performance data may be obtained, e.g., from a network management system (NMS) in the network.

In Step 112 a distance is determined for each of one or more neighbor relations identified in the existing neighbor relation list and in the performance report. The distance may be computed using known location coordinates for the cell under evaluation and for each neighbor identified in the existing neighbor relation list or the performance report.

In Step 114 non-co-located neighbors in the existing neighbor relation list or the performance report are identified and counted. For example, each neighbor may be labeled or tagged as being co-located with a cell under evaluation or non-co-located with the cell under evaluation.

In Step 116 a list of unique neighbor frequencies is created based on the neighbor relation list and the performance report. Each neighbor has a frequency of operation associated therewith (where a frequency may include a band or may be limited to a sub-band) which may be common to the frequency of other neighbors. Therefore, Step 116 converts a list of neighbors to a list of unique neighbor frequencies so that neighbor augmenting can be performed for each unique neighbor frequency using a corresponding optimal distance threshold appropriate for that unique neighbor frequency.

In Step 118 an optimal distance threshold is computed for each of the unique neighbor frequencies. The optimal distance threshold (denoted as neighbor_opt_dist in FIG. 1) may be determined by the following formula:

neighbor_opt_distᵢ=Max{Bᵢ−offset,Cᵢ+offset,Aᵢ+offset}

where:
Aᵢ is the distance of the furthest acceptably performing neighbor in the list of neighbors associated with unique neighbor frequency (i), where a neighbor is determined to have an acceptable performance level based on one or more performance criteria (e.g., a number of successful handover operations performed with the cell under evaluation exceeds a threshold level and a handover success rate or frequency also exceeds a threshold level),
Bᵢ is the distance of the furthest unacceptably performing neighbor in the list of neighbors associated with unique neighbor frequency (i) (where a neighbor is determined to have unacceptable performance if acceptable performance threshold(s) is/are not met),
Cᵢ is the 99th percentile of distance of relevant neighbors in the list of neighbors associated with unique neighbor frequency (i), where a relevant neighbor is a neighbor that meets one or more relevance criteria. The relevance criteria may include, for example, a number of successful handover operations performed with the cell under evaluation exceeds a threshold level, but may exclude a handover success rate/frequency, and
the offset value is a configurable value that may be tuned to increase or decrease a degree of ANR augmentation; moreover, the offset value may vary depending on neighbor frequency and/or other criteria, such as whether the cell is in an urban or a rural area.

In certain embodiments, the value of Ci can be a configurable parameter that is configured by a network management engineer. Alternatively, it may be auto-detected or statistically derived. In the case of auto-detection, the parameter threshold could be computed using a contextual model such as morphology (urban, suburban, rural) or machine-learning (ML) based clustering. A statistically derived method makes use of statistical models such as a cumulative distribution function. Several permutations and combinations of contextual models, ML models, and statistical models can be used for parameter threshold determination.

Once at least one optimal distance threshold is calculated for a unique neighbor frequency, the method 200 cycles through and evaluates each of one or more non-co-located neighbors associated with the unique neighbor frequency and neighbors that exceed the corresponding optimal distance threshold are disabled. The method 200 may be iterated for each unique neighbor frequency for a cell. The method 200 includes multiple steps. For example, in Step 220, the distance of a first neighbor from the cell for which neighbors are being evaluated is compared to the appropriate neighbor optimal distance threshold. If the first neighbor's distance is greater than the threshold, the method proceeds to Step 222 to disable the neighbor. Then, in Step 224 a non-co-located neighbor counter is decremented and at Step 226 the counter is evaluated to determine if it has reached zero. If so, the method 200 ends at Step 228, otherwise the method repeats another cycle beginning at Step 220 with a second neighbor's distance being compared to the optimal distance threshold. However, if the first neighbor's distance is not greater than the threshold, the method 200 proceeds to Step 230 to check if the first neighbor is disabled. If not, the non-co-located neighbor counter is decremented and at Step 226 and the counter is checked at Step 226 to determine if another non-co-located neighbor should be evaluated.

If the first neighbor's distance is not greater than the threshold and it has been disabled, a check is made at Step 232 to see if the first neighbor was disabled previously by the distance-based disabling procedure implemented by method 200. If not, a record is made in a log at Step 234 to indicate that the neighbor is an anomaly and that the reason for poor performance does not appear to be distance related (e.g., a performance issue may be the reason for the neighbor having been disabled). Otherwise, if the first neighbor was disabled previously by the distance-based disabling procedure, the neighbor is re-enabled at Step 236. Then, the non-co-located neighbor counter is decremented and at Step 226 and the counter is checked at Step 226 to determine if another non-co-located neighbor should be evaluated.

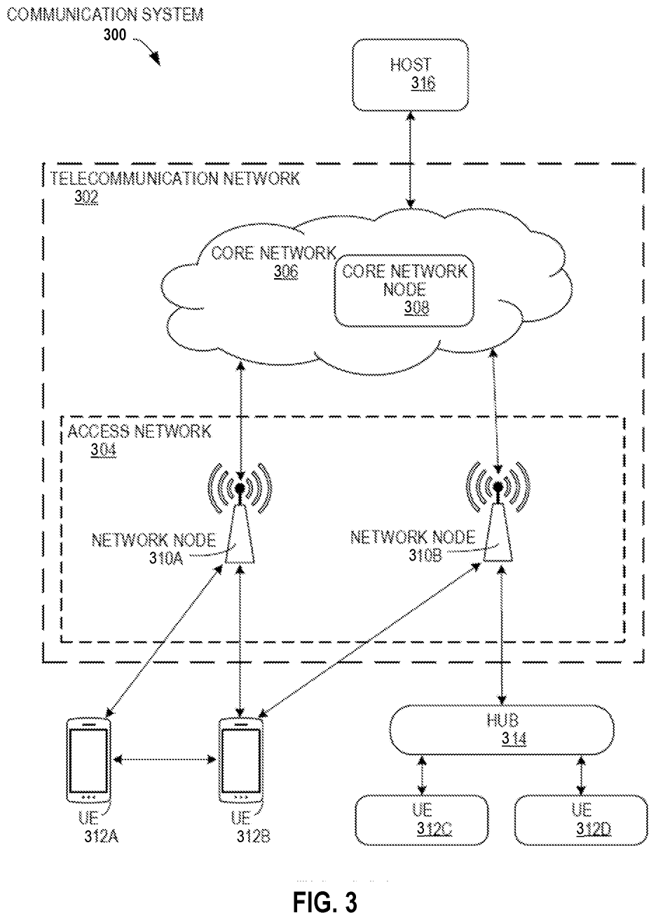

FIG. 3 shows an example of a communication system 300 in accordance with some embodiments. In the example, the communication system 300 includes a telecommunication network 302 that includes an access network 304, such as a radio access network (RAN), and a core network 306, which includes one or more core network nodes 308. The access network 304 includes one or more access network nodes, such as network nodes 310a and 310b (one or more of which may be generally referred to as network nodes 310), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 302 includes one or more Open-RAN (ORAN) network nodes. An ORAN network node is a node in the telecommunication network 302 that supports an ORAN specification (e.g., a specification published by the O-RAN Alliance, or any similar organization) and may operate alone or together with other nodes to implement one or more functionalities of any node in the telecommunication network 302, including one or more network nodes 310 and/or core network nodes 308.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 310 facilitate direct or indirect connection of user equipment (UE), such as by connecting UEs 312a, 312b, 312c, and 312d (one or more of which may be generally referred to as UEs 312) to the core network 306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 300 may include any number of wired or wireless networks, network nodes, UEs, and/or any other components or systems that may facilitate or participate in the communication of data and/or signals whether via wired or wireless connections. The communication system 300 may include and/or interface with any type of communication, telecommunication, data, cellular, radio network, and/or other similar type of system.

The UEs 312 may be any of a wide variety of communication devices, including wireless devices arranged, configured, and/or operable to communicate wirelessly with the network nodes 310 and other communication devices. Similarly, the network nodes 310 are arranged, capable, configured, and/or operable to communicate directly or indirectly with the UEs 312 and/or with other network nodes or equipment in the telecommunication network 302 to enable and/or provide network access, such as wireless network access, and/or to perform other functions, such as administration in the telecommunication network 302.

In the depicted example, the core network 306 connects the network nodes 310 to one or more hosts, such as host 316. These connections may be direct or indirect via one or more intermediary networks or devices. In other examples, network nodes may be directly coupled to hosts. The core network 306 includes one more core network nodes (e.g., core network node 308) that are structured with hardware and software components. Features of these components may be substantially similar to those described with respect to the UEs, network nodes, and/or hosts, such that the descriptions thereof are generally applicable to the corresponding components of the core network node 308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 316 may be under the ownership or control of a service provider other than an operator or provider of the access network 304 and/or the telecommunication network 302, and may be operated by the service provider or on behalf of the service provider. The host 316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 300 of FIG. 3 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 302 is a cellular network that implements 3GPP standardized features. Accordingly, the telecommunications network 302 may support network slicing to provide different logical networks to different devices that are connected to the telecommunication network 302. For example, the telecommunications network 302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 312 are configured to transmit and/or receive information without direct human interaction. For instance, a UE may be designed to transmit information to the access network 304 on a predetermined schedule, when triggered by an internal or external event, or in response to requests from the access network 304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 314 communicates with the access network 304 to facilitate indirect communication between one or more UEs (e.g., UE 312c and/or 312d) and network nodes (e.g., network node 310b). In some examples, the hub 314 may be a controller, router, content source and analytics, or any of the other communication devices described herein regarding UEs. For example, the hub 314 may be a broadband router enabling access to the core network 306 for the UEs. As another example, the hub 314 may be a controller that sends commands or instructions to one or more actuators in the UEs. Commands or instructions may be received from the UEs, network nodes 310, or by executable code, script, process, or other instructions in the hub 314. As another example, the hub 314 may be a data collector that acts as temporary storage for UE data and, in some embodiments, may perform analysis or other processing of the data. As another example, the hub 314 may be a content source. For example, for a UE that is a VR headset, display, loudspeaker or other media delivery device, the hub 314 may retrieve VR assets, video, audio, or other media or data related to sensory information via a network node, which the hub 314 then provides to the UE either directly, after performing local processing, and/or after adding additional local content. In still another example, the hub 314 acts as a proxy server or orchestrator for the UEs, in particular if one or more of the UEs are low energy IoT devices.

The hub 314 may have a constant/persistent or intermittent connection to the network node 310b. The hub 314 may also allow for a different communication scheme and/or schedule between the hub 314 and UEs (e.g., UE 312c and/or 312d), and between the hub 314 and the core network 306. In other examples, the hub 314 is connected to the core network 306 and/or one or more UEs via a wired connection. Moreover, the hub 314 may be configured to connect to an M2M service provider over the access network 304 and/or to another UE over a direct connection. In some scenarios, UEs may establish a wireless connection with the network nodes 310 while still connected via the hub 314 via a wired or wireless connection. In some embodiments, the hub 314 may be a dedicated hub—that is, a hub whose primary function is to route communications to/from the UEs from/to the network node 310b. In other embodiments, the hub 314 may be a non-dedicated hub—that is, a device which is capable of operating to route communications between the UEs and network node 310b, but which is additionally capable of operating as a communication start and/or end point for certain data channels.

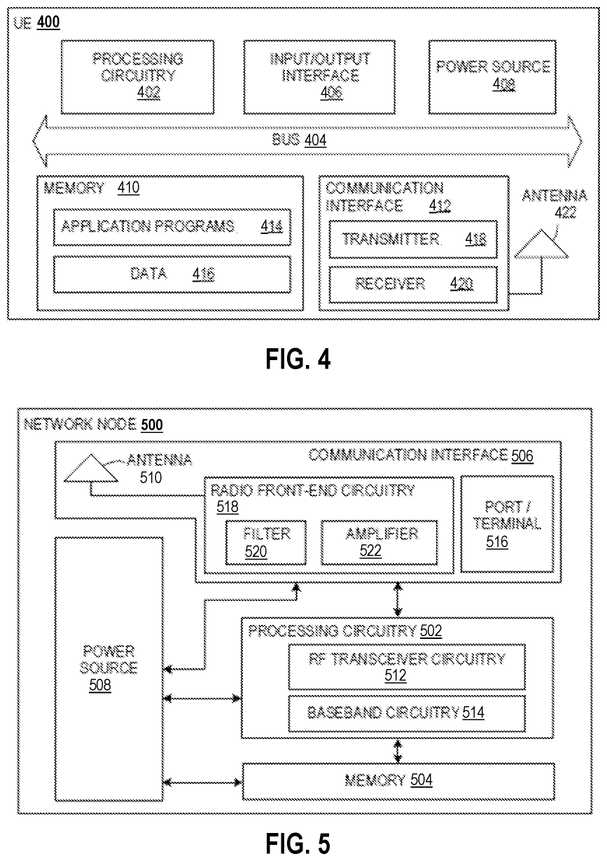

FIG. 4 shows a UE 400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 400 includes processing circuitry 402 that is operatively coupled via a bus 404 to an input/output interface 406, a power source 408, a memory 410, a communication interface 412, and/or any other component, or any combination thereof. Certain UEs may utilize all or a subset of the components shown in FIG. 4. The level of integration between the components may vary from one UE to another UE. Further, certain UEs may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 410. The processing circuitry 402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 402 may include multiple central processing units (CPUs).

In the example, the input/output interface 406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 408 is structured as a battery or battery pack. Other types of power sources, such as an external power source (e.g., an electricity outlet), photovoltaic device, or power cell, may be used. The power source 408 may further include power circuitry for delivering power from the power source 408 itself, and/or an external power source, to the various parts of the UE 400 via input circuitry or an interface such as an electrical power cable. Delivering power may be, for example, for charging of the power source 408. Power circuitry may perform any formatting, converting, or other modification to the power from the power source 408 to make the power suitable for the respective components of the UE 400 to which power is supplied.

The memory 410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 410 includes one or more application programs 414, such as an operating system, web browser application, a widget, gadget engine, or other application, and corresponding data 416. The memory 410 may store, for use by the UE 400, any of a variety of various operating systems or combinations of operating systems.

The memory 410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMS), such as a USIM and/or ISIM, other memory, or any combination thereof. The UICC may for example be an embedded UICC (eUICC), integrated UICC (iUICC) or a removable UICC commonly known as ‘SIM card.’ The memory 410 may allow the UE 400 to access instructions, application programs and the like, stored on transitory or non-transitory memory media, to off-load data, or to upload data. An article of manufacture, such as one utilizing a communication system may be tangibly embodied as or in the memory 410, which may be or comprise a device-readable storage medium.

The processing circuitry 402 may be configured to communicate with an access network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers of another device capable of wireless communication (e.g., another UE or a network node in an access network). Each transceiver may include a transmitter 418 and/or a receiver 420 appropriate to provide network communications (e.g., optical, electrical, frequency allocations, and so forth). Moreover, the transmitter 418 and receiver 420 may be coupled to one or more antennas (e.g., antenna 422) and may share circuit components, software or firmware, or alternatively be implemented separately.

In the illustrated embodiment, communication functions of the communication interface 412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 400 shown in FIG. 4.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 5 shows a network node 500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 500 includes a processing circuitry 502, a memory 504, a communication interface 506, and a power source 508. The network node 500 may be composed of multiple physically separate components (e.g., a NodeB component and a RNC component, or a BTS component and a BSC component, etc.), which may each have their own respective components. In certain scenarios in which the network node 500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 500 may be configured to support multiple radio access technologies (RATs). In such embodiments, some components may be duplicated (e.g., separate memory 504 for different RATs) and some components may be reused (e.g., a same antenna 510 may be shared by different RATs). The network node 500 may also include multiple sets of the various illustrated components for different wireless technologies integrated into network node 500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 500.

The processing circuitry 502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 500 components, such as the memory 504, to provide network node 500 functionality.

In some embodiments, the processing circuitry 502 includes a system on a chip (SOC). In some embodiments, the processing circuitry 502 includes one or more of radio frequency (RF) transceiver circuitry 512 and baseband processing circuitry 514. In some embodiments, the radio frequency (RF) transceiver circuitry 512 and the baseband processing circuitry 514 may be on separate chips (or sets of chips), boards, or units, such as radio units and digital units. In alternative embodiments, part or all of RF transceiver circuitry 512 and baseband processing circuitry 514 may be on the same chip or set of chips, boards, or units.

The memory 504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 502. The memory 504 may store any suitable instructions, data, or information, including a computer program, software, an application including one or more of logic, rules, code, tables, and/or other instructions capable of being executed by the processing circuitry 502 and utilized by the network node 500. The memory 504 may be used to store any calculations made by the processing circuitry 502 and/or any data received via the communication interface 506. In some embodiments, the processing circuitry 502 and memory 504 is integrated.

The communication interface 506 is used in wired or wireless communication of signaling and/or data between a network node, access network, and/or UE. As illustrated, the communication interface 506 comprises port(s)/terminal(s) 516 to send and receive data, for example to and from a network over a wired connection. The communication interface 506 also includes radio front-end circuitry 518 that may be coupled to, or in certain embodiments a part of, the antenna 510. Radio front-end circuitry 518 comprises filters 520 and amplifiers 522. The radio front-end circuitry 518 may be connected to an antenna 510 and processing circuitry 502. The radio front-end circuitry may be configured to condition signals communicated between antenna 510 and processing circuitry 502. The radio front-end circuitry 518 may receive digital data that is to be sent out to other network nodes or UEs via a wireless connection. The radio front-end circuitry 518 may convert the digital data into a radio signal having the appropriate channel and bandwidth parameters using a combination of filters 520 and/or amplifiers 522. The radio signal may then be transmitted via the antenna 510. Similarly, when receiving data, the antenna 510 may collect radio signals which are then converted into digital data by the radio front-end circuitry 518. The digital data may be passed to the processing circuitry 502. In other embodiments, the communication interface may comprise different components and/or different combinations of components.

In certain alternative embodiments, the network node 500 does not include separate radio front-end circuitry 518, instead, the processing circuitry 502 includes radio front-end circuitry and is connected to the antenna 510. Similarly, in some embodiments, all or some of the RF transceiver circuitry 512 is part of the communication interface 506. In still other embodiments, the communication interface 506 includes one or more ports or terminals 516, the radio front-end circuitry 518, and the RF transceiver circuitry 512, as part of a radio unit (not shown), and the communication interface 506 communicates with the baseband processing circuitry 514, which is part of a digital unit (not shown).

The antenna 510 may include one or more antennas, or antenna arrays, configured to send and/or receive wireless signals. The antenna 510 may be coupled to the radio front-end circuitry 518 and may be any type of antenna capable of transmitting and receiving data and/or signals wirelessly. In certain embodiments, the antenna 510 is separate from the network node 500 and connectable to the network node 500 through an interface or port.

The antenna 510, communication interface 506, and/or the processing circuitry 502 may be configured to perform any receiving operations and/or certain obtaining operations described herein as being performed by the network node. Any information, data and/or signals may be received from a UE, another network node and/or any other network equipment. Similarly, the antenna 510, the communication interface 506, and/or the processing circuitry 502 may be configured to perform any transmitting operations described herein as being performed by the network node. Any information, data and/or signals may be transmitted to a UE, another network node and/or any other network equipment.

The power source 508 provides power to the various components of network node 500 in a form suitable for the respective components (e.g., at a voltage and current level needed for each respective component). The power source 508 may further comprise, or be coupled to, power management circuitry to supply the components of the network node 500 with power for performing the functionality described herein. For example, the network node 500 may be connectable to an external power source (e.g., the power grid, an electricity outlet) via an input circuitry or interface such as an electrical cable, whereby the external power source supplies power to power circuitry of the power source 508. As a further example, the power source 508 may comprise a source of power in the form of a battery or battery pack which is connected to, or integrated in, power circuitry. The battery may provide backup power should the external power source fail.

Embodiments of the network node 500 may include additional components beyond those shown in FIG. 5 for providing certain aspects of the network node's functionality, including any of the functionality described herein and/or any functionality necessary to support the subject matter described herein. For example, the network node 500 may include user interface equipment to allow input of information into the network node 500 and to allow output of information from the network node 500. This may allow a user to perform diagnostic, maintenance, repair, and other administrative functions for the network node 500.

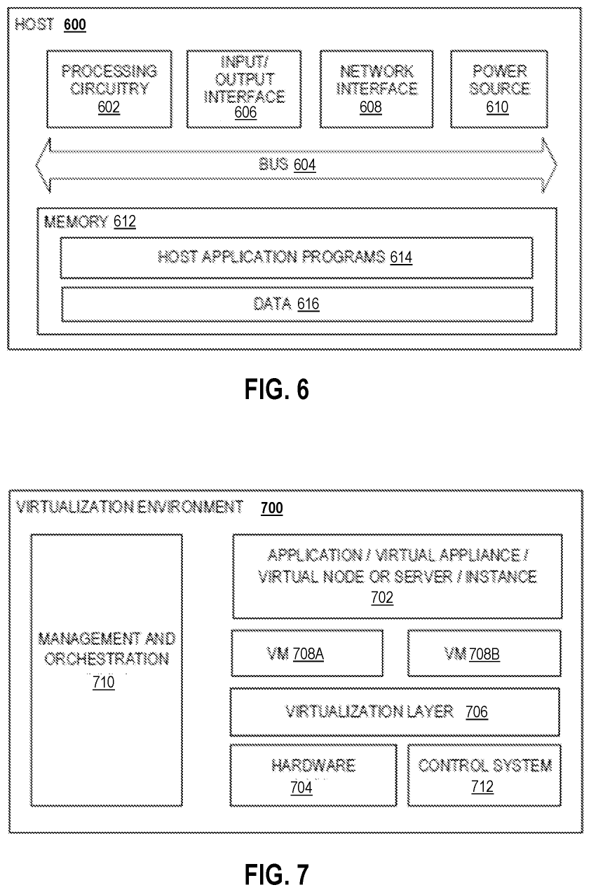

FIG. 6 is a block diagram of a host 600, which may be an embodiment of the host 316 of FIG. 3, in accordance with various aspects described herein. As used herein, the host 600 may be or comprise various combinations hardware and/or software, including a standalone server, a blade server, a cloud-implemented server, a distributed server, a virtual machine, container, or processing resources in a server farm. The host 600 may provide one or more services to one or more UEs.

The host 600 includes processing circuitry 602 that is operatively coupled via a bus 604 to an input/output interface 606, a network interface 608, a power source 610, and a memory 612. Other components may be included in other embodiments. Features of these components may be substantially similar to those described with respect to the devices of previous figures, such as FIGS. 4 and 5, such that the descriptions thereof are generally applicable to the corresponding components of host 600.

The memory 612 may include one or more computer programs including one or more host application programs 614 and data 616, which may include user data, e.g., data generated by a UE for the host 600 or data generated by the host 600 for a UE. Embodiments of the host 600 may utilize only a subset or all of the components shown. The host application programs 614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 614 may also provide for user authentication and licensing checks and may periodically report health, routes, and content availability to a central node, such as a device in or on the edge of a core network. Accordingly, the host 600 may select and/or indicate a different host for over-the-top services for a UE. The host application programs 614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 7 is a block diagram illustrating a virtualization environment 700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 700 includes components defined by the O-RAN Alliance, such as an O-Cloud environment orchestrated by a Service Management and Orchestration Framework via an O-2 interface.

Applications 702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 706 (also referred to as hypervisors or virtual machine monitors (VMMs)), provide VMs 708a and 708b (one or more of which may be generally referred to as VMs 708), and/or perform any of the functions, features and/or benefits described in relation with some embodiments described herein. The virtualization layer 706 may present a virtual operating platform that appears like networking hardware to the VMs 708.

The VMs 708 comprise virtual processing, virtual memory, virtual networking or interface and virtual storage, and may be run by a corresponding virtualization layer 706. Different embodiments of the instance of a virtual appliance 702 may be implemented on one or more of VMs 708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 708 may be a software implementation of a physical machine that runs programs as if they were executing on a physical, non-virtualized machine. Each of the VMs 708, and that part of hardware 704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 708 on top of the hardware 704 and corresponds to the application 702.

Hardware 704 may be implemented in a standalone network node with generic or specific components. Hardware 704 may implement some functions via virtualization. Alternatively, hardware 704 may be part of a larger cluster of hardware (e.g. such as in a data center or CPE) where many hardware nodes work together and are managed via management and orchestration 710, which, among others, oversees lifecycle management of applications 702. In some embodiments, hardware 704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 712 which may alternatively be used for communication between hardware nodes and radio units.

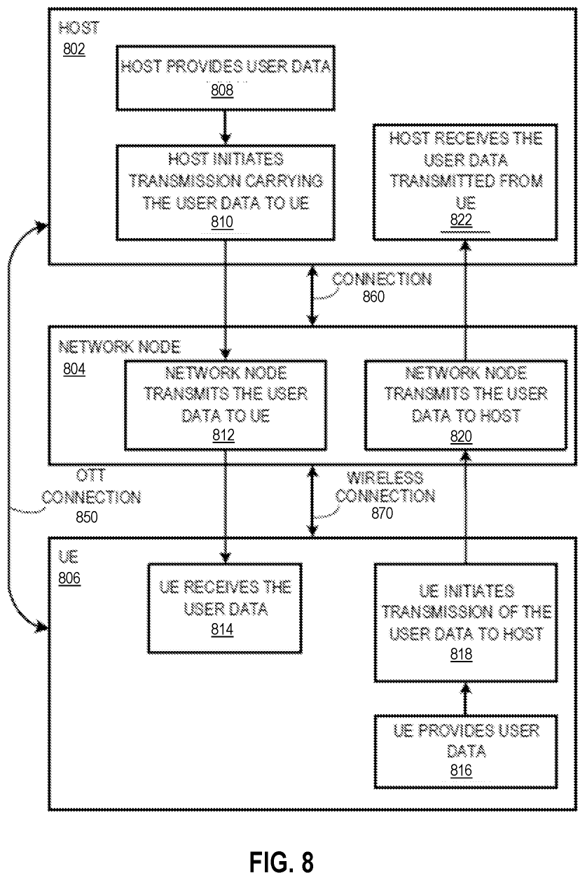

FIG. 8 shows a communication diagram of a host 802 communicating via a network node 804 with a UE 806 over a partially wireless connection in accordance with some embodiments. Example implementations, in accordance with various embodiments, of the UE (such as a UE 312a of FIG. 3 and/or UE 400 of FIG. 4), network node (such as network node 310a of FIG. 3 and/or network node 500 of FIG. 5), and host (such as host 316 of FIG. 3 and/or host 600 of FIG. 6) discussed in the preceding paragraphs will now be described with reference to FIG. 8.

Like host 600, embodiments of host 802 include hardware, such as a communication interface, processing circuitry, and memory. The host 802 also includes software, which is stored in or accessible by the host 802 and executable by the processing circuitry. The software includes a host application that may be operable to provide a service to a remote user, such as the UE 806 connecting via an over-the-top (OTT) connection 850 extending between the UE 806 and host 802. In providing the service to the remote user, a host application may provide user data which is transmitted using the OTT connection 850.

The network node 804 includes hardware enabling it to communicate with the host 802 and UE 806. The connection 860 may be direct or pass through a core network (like core network 306 of FIG. 3) and/or one or more other intermediate networks, such as one or more public, private, or hosted networks. For example, an intermediate network may be a backbone network or the Internet.

The UE 806 includes hardware and software, which is stored in or accessible by UE 806 and executable by the UE's processing circuitry. The software includes a client application, such as a web browser or operator-specific “app” that may be operable to provide a service to a human or non-human user via UE 806 with the support of the host 802. In the host 802, an executing host application may communicate with the executing client application via the OTT connection 850 terminating at the UE 806 and host 802. In providing the service to the user, the UE's client application may receive request data from the host's host application and provide user data in response to the request data. The OTT connection 850 may transfer both the request data and the user data. The UE's client application may interact with the user to generate the user data that it provides to the host application through the OTT connection 850.

The OTT connection 850 may extend via a connection 860 between the host 802 and the network node 804 and via a wireless connection 870 between the network node 804 and the UE 806 to provide the connection between the host 802 and the UE 806. The connection 860 and wireless connection 870, over which the OTT connection 850 may be provided, have been drawn abstractly to illustrate the communication between the host 802 and the UE 806 via the network node 804, without explicit reference to any intermediary devices and the precise routing of messages via these devices.

As an example of transmitting data via the OTT connection 850, in step 808, the host 802 provides user data, which may be performed by executing a host application. In some embodiments, the user data is associated with a particular human user interacting with the UE 806. In other embodiments, the user data is associated with a UE 806 that shares data with the host 802 without explicit human interaction. In step 810, the host 802 initiates a transmission carrying the user data towards the UE 806. The host 802 may initiate the transmission responsive to a request transmitted by the UE 806. The request may be caused by human interaction with the UE 806 or by operation of the client application executing on the UE 806. The transmission may pass via the network node 804, in accordance with the teachings of the embodiments described throughout this disclosure. Accordingly, in step 812, the network node 804 transmits to the UE 806 the user data that was carried in the transmission that the host 802 initiated, in accordance with the teachings of the embodiments described throughout this disclosure. In step 814, the UE 806 receives the user data carried in the transmission, which may be performed by a client application executed on the UE 806 associated with the host application executed by the host 802.

In some examples, the UE 806 executes a client application which provides user data to the host 802. The user data may be provided in reaction or response to the data received from the host 802. Accordingly, in step 816, the UE 806 may provide user data, which may be performed by executing the client application. In providing the user data, the client application may further consider user input received from the user via an input/output interface of the UE 806. Regardless of the specific manner in which the user data was provided, the UE 806 initiates, in step 818, transmission of the user data towards the host 802 via the network node 804. In step 820, in accordance with the teachings of the embodiments described throughout this disclosure, the network node 804 receives user data from the UE 806 and initiates transmission of the received user data towards the host 802. In step 822, the host 802 receives the user data carried in the transmission initiated by the UE 806.

One or more of the various embodiments improve the performance of OTT services provided to the UE 806 using the OTT connection 850, in which the wireless connection 870 forms the last segment. More precisely, the teachings of these embodiments may improve user perception of the network's performance and minimize subsequent impact to critical services offered by the network.

In an example scenario, factory status information may be collected and analyzed by the host 802. As another example, the host 802 may process audio and video data which may have been retrieved from a UE for use in creating maps. As another example, the host 802 may collect and analyze real-time data to assist in controlling vehicle congestion (e.g., controlling traffic lights). As another example, the host 802 may store surveillance video uploaded by a UE. As another example, the host 802 may store or control access to media content such as video, audio, VR or AR which it can broadcast, multicast or unicast to UEs. As other examples, the host 802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 850 between the host 802 and UE 806, in response to variations in the measurement results. The measurement procedure and/or the network functionality for reconfiguring the OTT connection may be implemented in software and hardware of the host 802 and/or UE 806. In some embodiments, sensors (not shown) may be deployed in or in association with other devices through which the OTT connection 850 passes; the sensors may participate in the measurement procedure by supplying values of the monitored quantities exemplified above, or supplying values of other physical quantities from which software may compute or estimate the monitored quantities. The reconfiguring of the OTT connection 850 may include message format, retransmission settings, preferred routing etc.; the reconfiguring need not directly alter the operation of the network node 804. Such procedures and functionalities may be known and practiced in the art. In certain embodiments, measurements may involve proprietary UE signaling that facilitates measurements of throughput, propagation times, latency and the like, by the host 802. The measurements may be implemented in that software causes messages to be transmitted, in particular empty or ‘dummy’ messages, using the OTT connection 850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Abbreviations

At least some of the following abbreviations may be used in this disclosure. If there is an inconsistency between abbreviations, preference should be given to how it is used above. If listed multiple times below, the first listing should be preferred over any subsequent listing(s).
3GPP 3rd Generation Partnership Project
5G 5th Generation
6G 6^{th} Generation
eNB E-UTRAN NodeB
gNB Base station in NR
LTE Long-Term Evolution
NR New Radio
OFDM Orthogonal Frequency Division Multiplexing
OFDMA Orthogonal Frequency Division Multiple Access
RAN Radio Access Network
RAT Radio Access Technology
RRC Radio Resource Control
UE User Equipment
UL Uplink

1. A method performed by a network node for augmenting automatic neighbor relations in a wireless communication network, the method comprising:
obtaining a list of neighbors of a cell in the wireless communication network and at least one performance characteristic associated with each of one or more of the neighbors;
determining a distance of each of the one or more neighbors from the cell;
determining a distance threshold based on the at least one performance characteristic;
comparing the distance of the one or more neighbors to the distance threshold; and
disabling one or more neighbors in the list from operating as a neighbor for the cell based on the distance threshold comparison.

2. The method of claim 1, further comprising:
identifying which of the neighbors in the list of neighbors are non-co-located with the cell,
wherein the one or more neighbors whose distances are compared to the distance threshold are non-co-located neighbors.

3. The method of claim 1, further comprising:
adjusting a counter after a first neighbor's distance is compared to the distance threshold; and
evaluating the counter to determine whether to compare a second neighbor's distance to the distance threshold.

4. The method of claim 1, further comprising:
creating a list of unique neighbor frequencies based on the list of neighbors,
wherein a distance threshold is determined for each of the unique neighbor frequencies and the comparing and disabling are performed for each of the distance thresholds corresponding to the unique neighbor frequencies.

5. The method of claim 1, wherein the list of neighbors includes an existing neighbor relation list derived from an ANR procedure and a list of neighbors derived from a performance report.

6. The method of claim 1, wherein a neighbor is disabled if the neighbor's distance is greater than the distance threshold.

7. The method of claim 1, further comprising:
checking if the neighbor is already disabled if the neighbor's distance is not greater than the distance threshold;
if the neighbor is already disabled, checking if the neighbor was disabled previously as a result of the neighbor's distance being greater than a previously determined distance threshold;
if the neighbor was disabled previously, logging an indication that the neighbor is classified as an anomaly;
if the neighbor is already disabled but was not disabled previously as a result of the neighbor's distance being greater than a previously determined distance threshold, re-enabling the neighbor in the list.

8. A network node for augmenting automatic neighbor relations in a wireless communication network, the network node comprising:
processing circuitry configured to:
obtain a list of neighbors of a cell in the wireless communication network and at least one performance characteristic associated with each of one or more of the neighbors;
determine a distance of each of the one or more neighbors from the cell;
determine a distance threshold based on the at least one performance characteristic;
compare the distance of the one or more neighbors to the distance threshold; and
disable one or more neighbors in the list from operating as a neighbor for the cell based on the distance threshold comparison; and
power supply circuitry configured to supply power to the processing circuitry.

9. The network node of claim 8, wherein the processing circuitry is further configured to:
identify which of the neighbors in the list of neighbors are non-co-located with the cell,
wherein the one or more neighbors whose distances are compared to the distance threshold are non-co-located neighbors.

10. The network node of claim 8, wherein the processing circuitry is further configured to:
adjust a counter after a first neighbor's distance is compared to the distance threshold; and
evaluate the counter to determine whether to compare a second neighbor's distance to the distance threshold.

11. The network node of claim 8, wherein the processing circuitry is further configured to:
create a list of unique neighbor frequencies based on the list of neighbors,
wherein a distance threshold is determined for each of the unique neighbor frequencies and the comparing and disabling are performed for each of the distance thresholds corresponding to the unique neighbor frequencies.

12. The network node of claim 8, wherein the list of neighbors includes an existing neighbor relation list derived from an ANR procedure and a list of neighbors derived from a performance report.

13. The network node of claim 8, wherein a neighbor is disabled if the neighbor's distance is greater than the distance threshold.

14. The network node of claim 8, wherein the processing circuitry is further configured to:
check if the neighbor is already disabled if the neighbor's distance is not greater than the distance threshold;
if the neighbor is already disabled, check if the neighbor was disabled previously as a result of the neighbor's distance being greater than a previously determined distance threshold;
if the neighbor was disabled previously, log an indication that the neighbor is classified as an anomaly;
if the neighbor is already disabled but was not disabled previously as a result of the neighbor's distance being greater than a previously determined distance threshold, re-enable the neighbor in the list.

15. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, wherein the processing circuitry of the network node is configured to:
obtain a list of neighbors of a cell in the wireless communication network and at least one performance characteristic associated with each of one or more of the neighbors;
determine a distance of each of the one or more neighbors from the cell;
determine a distance threshold based on the at least one performance characteristic;
compare the distance of the one or more neighbors to the distance threshold; and
disable one or more neighbors in the list from operating as a neighbor for the cell based on the distance threshold comparison.

16. The host of claim 15, wherein:
the processing circuitry of the host is configured to execute a host application that provides the user data; and
the UE comprises processing circuitry configured to execute a client application associated with the host application to receive the transmission of user data from the host.

17. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node is configured to:
obtain a list of neighbors of a cell in the wireless communication network and at least one performance characteristic associated with each of one or more of the neighbors;
determine a distance of each of the one or more neighbors from the cell;
determine a distance threshold based on the at least one performance characteristic;
compare the distance of the one or more neighbors to the distance threshold; and
disable one or more neighbors in the list from operating as a neighbor for the cell based on the distance threshold comparison.

18. The method of claim 17, further comprising, at the network node, transmitting the user data provided by the host for the UE.

19. The method of claim 17, wherein the user data is provided at the host by executing a host application that interacts with a client application executing on the UE, the client application being associated with the host application.
